(19) United States
(12) Patent Application Publication
(10) Pub. No.: US 2026/0330566 A1
(43) Pub. Date: Oct. 22, 2026

(54) LLM Enabled Insurance Errors and Omissions Verification

(71) Applicant: IAN Group, LLC, Amarillo, TX (US)

(72) Inventor: Trent Phillips, Amarillo, TX (US)

(21) Appl. No.: 19/651,587

(22) Filed: Apr. 17, 2026

Related U.S. Application Data
(60) Provisional application No. 63/790,662, filed on Apr. 17, 2025.

(51) Int. Cl. G06Q 40/08

(52) U.S. Cl. CPC G06Q 40/0821

(57) ABSTRACT

A computer-implemented insurance product creation system identifies coverage gaps in an insurance policy and generates an errors-and-omissions discharge record. A natural language processing application executes a large language model pipeline to extract structured exclusion objects from policy text and queries a policy database for similar policies. The system compares extracted exclusions against industry peers to identify gaps unique to the policy and queries an endorsement database for endorsements addressing the identified gaps. A recursive analysis examines each suggested endorsement for new exclusions it introduces and queries the endorsement database for further endorsements, terminating when no further endorsement is available; any remaining gaps are classified as tolerable coverage gaps. The system outputs both a final endorsement set and an offered-coverage audit record documenting, for each exclusion, the disposition of every available endorsement offered, providing documentary support for the agent's errors-and-omissions defense regardless of whether the client purchases the offered coverage.

### CROSS-REFERENCE TO RELATED APPLICATIONS

This application claims the benefit of priority under 35 U.S.C. § 119(e) to U.S. Provisional Patent Application No. 63/790,662, filed Apr. 17, 2025, and entitled “LLM Enabled Insurance Errors and Omissions Verification,” the entire contents of which are incorporated herein by reference.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

In the insurance industry, all policies include exclusions—conditions or scenarios where coverage does not apply. These exclusions are often detailed and complex, making it difficult for insurance agents, particularly those new to the field, to fully recognize and address them. The role of an insurance agent is to identify these exclusions and recommend endorsements—additional insurance products or modifications—to close gaps in coverage, ensuring clients are adequately protected.

Consider a scenario where a young insurance salesman receives a call from a plumber seeking coverage for their practice. The plumber requests a policy, and the salesman provides a general liability insurance plan, assuring the plumber it meets their needs. However, the salesman, lacking an expert's eye, overlooks an exclusion in the policy stating that damages from “failure to tighten a plumbing fixture on a toilet” are not covered. Later, a leak occurs due to this exact issue, and the plumber discovers the policy does not cover the resulting damages. Had the salesman identified this exclusion and offered an endorsement to cover it, the plumber would have been protected, avoiding financial loss and potential disputes.

Consider a second scenario, drawn from a higher-risk class of business. A neighborhood fireworks stand operator approaches the same agent ahead of the summer holiday season, looking for general liability coverage for the temporary stand. The agent pulls an off-the-shelf general liability policy and, on its face, the policy appears appropriate for a small retail operation. However, fireworks retail is a hazardous-classification business and off-the-shelf general liability forms typically contain exclusions for losses arising from the sale, handling, or storage of fireworks, pyrotechnic devices, and other explosive merchandise; for losses arising from operations conducted at temporary or seasonal premises; and for losses arising from product use by the purchaser after sale. Without a system to surface these exclusions, the agent may bind a policy that—from the operator's perspective—appears to provide general liability coverage for the operator's actual line of business but in fact excludes nearly every loss the operator is exposed to. The marketplace offers endorsements that close some of these gaps (for example, a fireworks-products endorsement, a temporary-premises endorsement, or a vendor's-liability endorsement), and the marketplace offers no endorsement at all for others (for example, intentional misconduct by the purchaser); but in either case, the agent's E&O posture turns on having identified each exclusion and offered each available endorsement to the operator before the policy is bound. The fireworks-stand example illustrates, more sharply than the plumber example, why a system that exhaustively surfaces exclusions and matches them to available endorsements is valuable: as the underlying business risk grows, the cost of a missed exclusion compounds.

Such situations highlight a common challenge: insurance agents must thoroughly understand policy terms and match them to a client's specific risks, a task made harder by the volume and complexity of policies they handle. Missed exclusions can lead to uncovered claims, leaving clients vulnerable and exposing agents to errors and omissions (E&O) liability if clients claim inadequate advisement.

The legal posture of E&O liability for insurance agents is important to the present disclosure. An agent's E&O exposure is materially reduced not by eliminating every coverage gap—which is frequently impossible, because the marketplace does not always offer an endorsement for every conceivable exclusion—but by documenting that the agent identified the gaps and offered the client every available form of coverage. Even where the client elects not to purchase a particular endorsement (for cost or other reasons), the documented offer itself discharges the agent's professional obligation. The system disclosed herein is designed around this principle: the system's output is not merely a coverage-gap checklist, but an auditable record of every exclusion identified and every available endorsement offered to the client, which serves as the agent's E&O defense in the event of a later claim.

There is a clear need for a system to assist insurance agents in this process. The proposed system addresses this by analyzing insurance policies to identify exclusions, comparing them to a database of similar policies and available endorsements, and generating a checklist of coverage gaps and suggested endorsements. This empowers agents to better inform clients of risks and mitigation options, such as contacting brokers for additional coverage.

Furthermore, the system can perform recursive analysis when an endorsement introduces new exclusions—so-called “child” or “grandchild” exclusions—identifying further endorsements to ensure comprehensive coverage. A tolerable coverage gap is one for which no further endorsement is available in the marketplace; once the system has exhausted available endorsements addressing remaining exclusions, those remaining gaps are tolerable in the E&O sense because the agent's documented offer of every available endorsement discharges the agent's professional obligation regardless of whether the client purchases the offered coverage. By automating this process and producing the auditable offer record, the system reduces the likelihood of oversight, enhances client protection, and mitigates agent liability.

Prior art from the Applicant's prior filing (15047599 filed Feb. 18, 2006) includes several references cited in the Notice of References Cited. These references include US-20020265560-A1, attributed to Colagiovanni, JR., Joseph A., dated October 2002; US-8494882-B1, attributed to Hopkins, John C., dated July 2003; US-20020265559-A1, also attributed to Colagiovanni, JR., Joseph A., dated October 2002; US-20040278577-A1, attributed to Baum, Philip, dated September 2004; and US-20050187016-A1, attributed to Adams, Isaac D., dated July 2005. These references have been reviewed and considered in the context of the subsequent filing by the Applicant.

None of the prior cited references are seen to anticipate this filing.

### BRIEF SUMMARY OF THE INVENTION

An insurance product creation system 100 for identifying and addressing coverage gaps in an insurance policy and for generating an errors-and-omissions discharge record, is disclosed that comprises one or more computers 108, each comprising a memory 110, one or more processors 112, network hardware 114, and one or more applications 116 stored in the memory 110 and executable by the one or more processors 112. A policy database 120 storing a plurality of insurance policies categorized by industry. An endorsement database 122 storing a plurality of endorsements and, for each endorsement, any new exclusion introduced by the endorsement. Where the one or more applications 116, when executed by the one or more processors 112, are configured to: receive insurance policy data and client information. Extract, by a NLP application 116e of the one or more applications 116, a plurality of exclusion objects 612 from the insurance policy data, each exclusion object of the exclusion objects 612 comprising an exclusion identifier, an exclusion text, a coverage category, and a confidence score. Retrieve, from the policy database 120, a set of similar policies based on an industry classification associated with the client information. Compare each of the exclusion objects 612 against exclusions found in the set of similar policies to identify one or more potential coverage gaps unique to the insurance policy data. Query the endorsement database 122 for each identified potential coverage gap to generate an endorsement suggestion list. Perform a recursive analysis of the endorsement suggestion list by, for each endorsement in the endorsement suggestion list, analyzing the endorsement text using the NLP application 116e to identify any new exclusions introduced by the endorsement and querying the endorsement database 122 for further endorsements addressing the new exclusions, the recursive analysis terminating upon satisfaction of at least one of no new exclusions being identified in the analyzed endorsements, the endorsement database 122 containing no further endorsement addressing remaining new exclusions, and a predetermined recursion-depth limit being reached. Output a final endorsement set, and an offered-coverage audit record 530 comprising, for each of the exclusion objects 612, a recorded disposition of at least one available endorsement offered with respect to the exclusion object.

A method for identifying and addressing coverage gaps in an insurance policy and for generating an errors-and-omissions discharge record, the method being performed by one or more processors 112 of one or more computers 108 operating on data stored in a memory 110 of the one or more computers 108, the method is disclosed that comprises receiving, by the one or more processors 112, insurance policy data and client information. Extracting, by a NLP application 116e executed by the one or more processors 112, a plurality of exclusion objects 612 from the insurance policy data, each exclusion object of the exclusion objects 612 comprising an exclusion identifier, an exclusion text, a coverage category, and a confidence score. Retrieving, by the one or more processors 112 from a policy database 120, a set of similar policies based on an industry classification associated with the client information. Comparing, by the one or more processors 112, each of the exclusion objects 612 against exclusions found in the set of similar policies to identify one or more potential coverage gaps unique to the insurance policy data. Querying, by the one or more processors 112, an endorsement database 122 for each identified potential coverage gap to generate an endorsement suggestion list. Performing, by the one or more processors 112, a recursive analysis of the endorsement suggestion list, the recursive analysis comprising iteratively analyzing each endorsement in the endorsement suggestion list for any new exclusion introduced by the endorsement and querying the endorsement database 122 for further endorsements addressing the new exclusion, the recursive analysis terminating when the endorsement database 122 contains no further endorsement capable of addressing a remaining new exclusion. Generating, by the one or more processors 112, an offered-coverage audit record 530 documenting, for each of the exclusion objects 612, a recorded disposition of at least one available endorsement offered with respect to the exclusion object, the offered-coverage audit record 530 serving as a record of every available endorsement offered with respect to the insurance policy for purposes of discharging an errors-and-omissions obligation of an insurance agent.

A NLP application 116e for extracting exclusions from an insurance policy, the apparatus is disclosed that comprises one or more processors 112. A memory 110 coupled to the one or more processors 112, the memory 110 storing instructions that, when executed by the one or more processors 112, cause the apparatus to: receive insurance policy text. Construct, by a prompt engineering module 604 of the apparatus, a prompt comprising extraction instructions specifying one or more categories of exclusion information to be extracted, an output format specification defining a structured exclusion object schema, and at least a section of the insurance policy text. Submit the prompt to a LLM processing engine 606 of the apparatus and receive a textual response from the LLM processing engine 606. Parse, by an extraction parser 608 of the apparatus, the textual response against the output format specification to produce a plurality of candidate exclusion objects, each candidate exclusion object comprising an exclusion identifier, an exclusion text, a coverage category, and a confidence score. Filter the plurality of candidate exclusion objects by comparing each candidate exclusion object's confidence score against a predetermined threshold. Output the filtered candidate exclusion objects as a set of exclusion objects 612 for use by a coverage-gap analysis system.

### BRIEF DESCRIPTION OF THE SEVERAL VIEWS OF THE DRAWING

FIG. 1 illustrates an insurance product creation system 100.

FIG. 2 illustrates an interaction diagram 200 between said one or more applications 116 of said one or more computers 108 within said insurance product creation system 100.

FIG. 3 illustrates a flowchart 300 of the main method for identifying and addressing coverage gaps in an insurance policy.

FIG. 4 illustrates a flowchart 400 of the recursive analysis process for suggested endorsements.

FIG. 5 illustrates an user interface 500 for presenting the checklist and endorsements to the user.

FIG. 6 illustrates an internal architecture of said NLP application 116e, comprising a pipeline of processing modules that transform raw insurance policy text into structured exclusion objects.

FIG. 7 illustrates a flowchart 700 of an exclusion extraction method performed by said NLP application 116e on a received insurance policy document.

FIG. 8 illustrates a data architecture of said policy database 120, showing relationships among policy records, industry classifications, and exclusion records.

FIG. 9 illustrates a data architecture of said endorsement database 122, showing relationships among endorsement records, exclusion-coverage mappings, and new exclusions that may be introduced by an endorsement.

FIG. 10 illustrates a flowchart 1000 detailing the comparison process performed at said fourth step 308 of the flowchart 300, wherein extracted exclusions are compared against exclusions found in similar policies and against available endorsements to identify coverage gaps and tolerable coverage gaps.

FIG. 11 illustrates a flowchart 1100 of the recursive analysis process showing three termination conditions, including a primary termination based on exhaustion of available endorsements addressing remaining exclusions, with the resulting output comprising both a final endorsement set and a documented offer record supporting the agent's E&O posture.

FIG. 12 illustrates an end-to-end example of system operation using a worked plumber-policy scenario, depicting message exchange between the agent 102b, said insurance product creation system 100, said NLP application 116e, said policy database 120, and said endorsement database 122.

FIG. 13 illustrates a data architecture of said offered-coverage audit record 530, showing the fields of an audit entry 1302 and the one-to-many relationship between said offered-coverage audit record 530 and its constituent audit entries.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

### Note on Hardware Realization of the Disclosed Computational Steps

Each step described herein as performed by an insurance product creation system 100, by NLP application 116e, or by any other software component of this disclosure is a computational step executed by one or more processors 112 of one or more of one or more computers 108, operating on data held in a memory 110 of one or more of said one or more computers 108, and—where the step involves communication between said one or more computers 108—mediated by a network hardware 114 of those computers across a network 130. References herein to “natural language processing,” “large language model” or “LLM” operations, “generative artificial intelligence” operations, “semantic similarity” operations, “vector embeddings,” and similar machine-learning constructs refer to specific software operations performed by said one or more processors 112, including, by way of example and without limitation: the loading of model parameters from said memory 110 or from persistent storage into the working memory of said one or more processors 112; the execution of arithmetic operations (such as matrix multiplications and non-linear activations) by said one or more processors 112 (which may include central processing unit cores, graphics processing unit cores, tensor processing unit cores, or other specialized arithmetic hardware); and the writing of resulting output data back to said memory 110. Where this disclosure describes an operation as “performed by an LLM” or “performed by a LLM processing engine 606,” it is understood that the operation may be performed (i) on hardware locally attached to one of said one or more computers 108, or (ii) by submitting a request over said network 130 (by way of an application programming interface, an “API”) to a remote computing resource that performs the operation on its own one or more processors 112 and returns a result over said network 130. In either case, the operation is a series of deterministic computational steps performed by computer hardware, and is not a mental act or an abstract idea. The use of generative artificial intelligence in this disclosure refers to the application of trained statistical models—comprising numerical model parameters stored in computer-readable storage—to input data in order to produce output data; no human cognition is involved in the operation of the disclosed pipeline once the operation has been initiated, although a human (such as agent 102b) initiates the operation and consumes its outputs through an user interface 500.

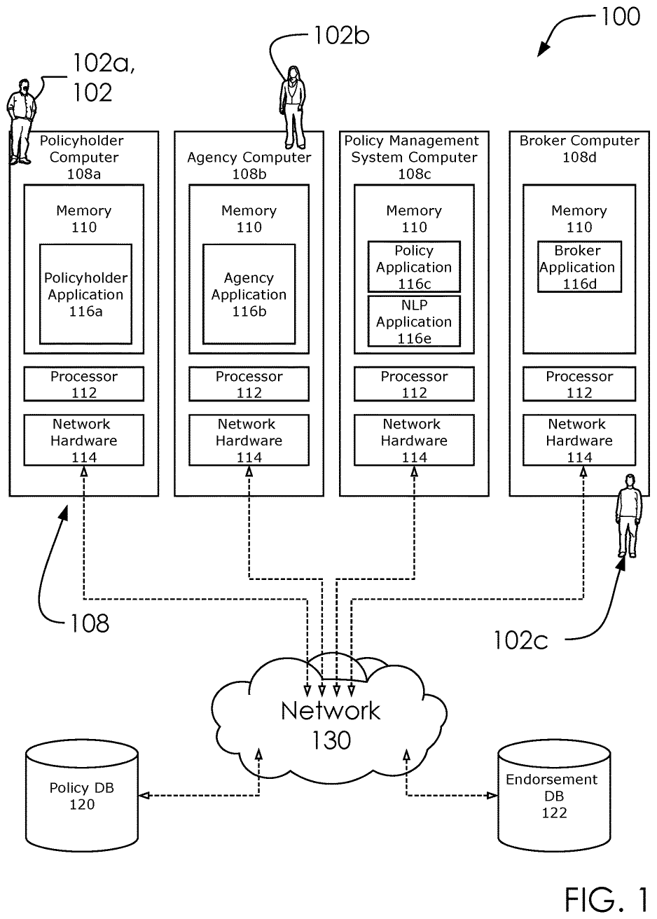

FIG. 1 illustrates the insurance product creation system 100.

In one embodiment, said insurance product creation system 100 can comprise one or more computers 108 at one or more locations.

Said one or more computers 108 can each comprise the memory 110, one or more processors 112, the network hardware 114, and one or more applications 116 run in said memory 110.

Said network 130 can be a local area network (LAN), a wide area network (WAN), a piconet, or a combination of LANs, WANs, or piconets. One illustrative LAN is a network within a single business. One illustrative WAN is the Internet.

Said insurance product creation system 100 can operate on said one or more computers 108 as between one or more transaction parties 102. For example, a policyholder computer 108a associated with a policyholder 102a; an agent computer 108b associated with the agent 102b; and a broker computer 108d associated with a broker 102c. Likewise, said one or more applications 116 of each among one or more computers 108 can be associated with the needs of said one or more computers 108 and said insurance product creation system 100. For example, said policyholder 102a can comprise a policyholder application 116a, said agent 102b can comprise an agency application 116b, and a policy management computer 108c can comprise a broker application 116d.

Said one or more computers 108 can further comprise the policy management computer 108c having a policy application 116c for managing transaction between said one or more transaction parties 102.

Said insurance product creation system 100 can further comprise a policy database 120 and an endorsement database 122.

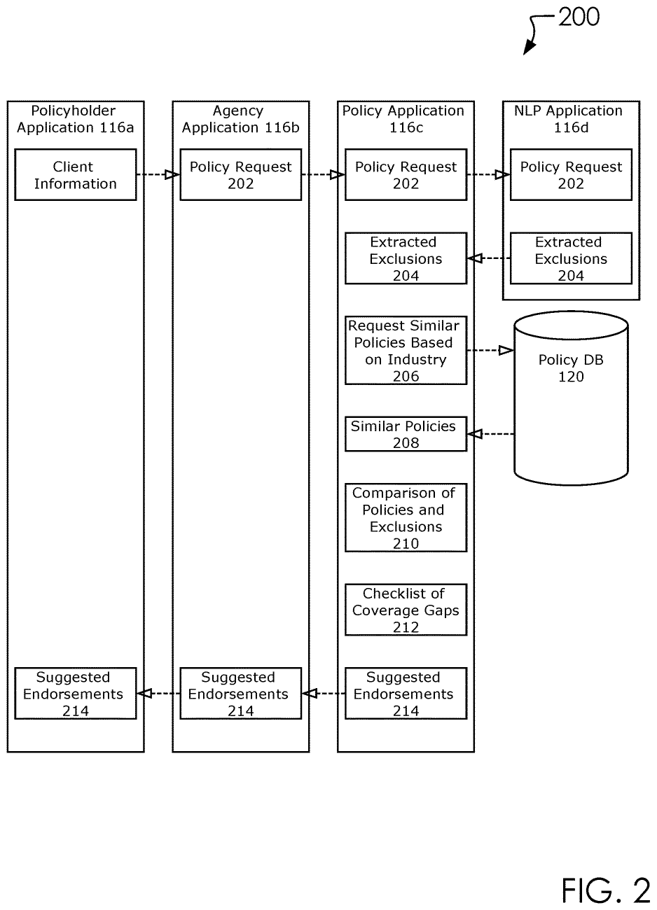

FIG. 2 illustrates an interaction diagram 200 between said one or more applications 116 of said one or more computers 108 within said insurance product creation system 100.

In one embodiment, said policy application 116c can receive a policy request 202 from a user, such as the agent 102b. The policy request 202 can include insurance policy data and client information. Upon receiving said policy request 202, said policy application 116c can forward the request to the NLP application 116e for analysis.

Said NLP application 116e can process said policy request 202 using natural language processing techniques to extract one or more exclusions 204 from the policy text.

Said broker application 116d can return said one or more exclusions 204 to said policy application 116c. After extracting said one or more exclusions 204, said insurance product creation system 100 can generate a request for similar policies 206 based on the client's industry classification. This request can be sent to said policy database 120, which contains a collection of insurance policies categorized by industry. Said policy database 120 can return similar policies 208 that match the industry criteria.

In one embodiment, said NLP application 116e can comprise generative artificial intelligence algorithms such as Large Language Models (LLMs) or similar, as is known in the art. In one embodiment, said broker application 116d can be operated on an API or separate system not shown in the Figures.

Said insurance product creation system 100 can then calculate a comparison list 210 of the one or more exclusions 204 with the exclusions found in said similar policies 208. Based on this comparison, said NLP application 116e can identify coverage gaps and generate a checklist of coverage gaps 212. Additionally, said insurance product creation system 100 can calculate an endorsement suggestion list 214 to address the identified coverage gaps. Said checklist of coverage gaps 212 and said endorsement suggestion list 214 can be sent back to said policy application 116c and said agency application 116b for presentation to the user.

This interaction ensures that said insurance product creation system 100 efficiently processes policy requests and provides valuable insights to insurance agents.

In one embodiment, said policyholder application 116a is not part of the process of said insurance product creation system 100. Wherein, said policyholder 102a interacts with said agent 102b directly or by person-to-person communication; and said agent 102b enters said policy request 202 based on said conversation. Whereupon, said policyholder 102a can receive the outcome of the conversation by verbal means or by printed report.

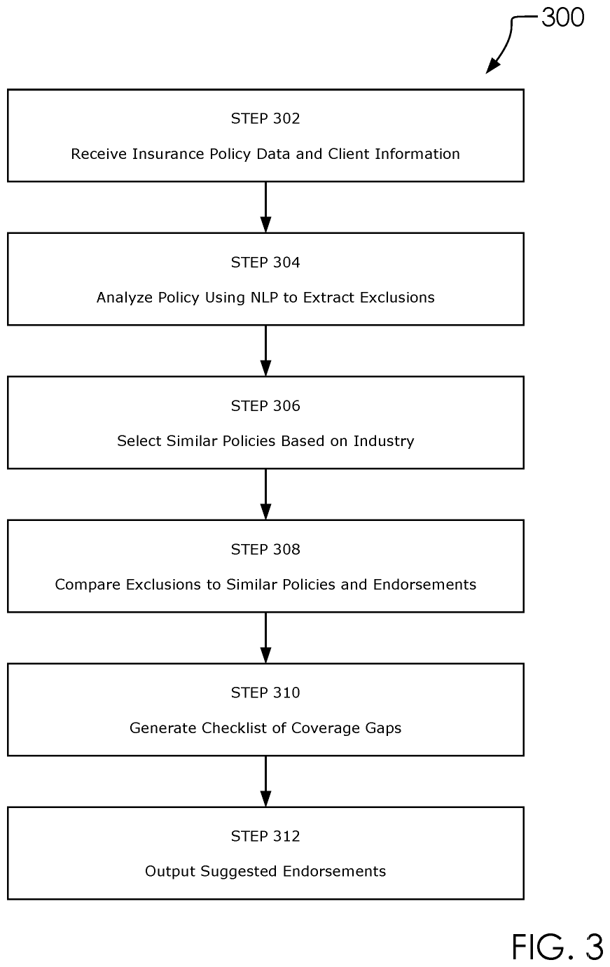

FIG. 3 illustrates a flowchart 300 of the main method for identifying and addressing coverage gaps in an insurance policy.

The method begins with a first step 302, where said insurance product creation system 100 receives insurance policy data and client information. In one embodiment, this step can involve said policy application 116c accepting input from said agent 102b through a user interface.

Next, in a second step 304, said insurance product creation system 100 analyzes the policy using natural language processing (NLP) to extract exclusions. This step can be performed by said NLP application 116e, which processes the policy text to identify exclusion clauses.

Following the extraction, in a third step 306, said insurance product creation system 100 selects similar policies based on the client's industry. This involves querying said policy database 120 to retrieve policies that match the industry classification provided in the client information.

In a fourth step 308, said insurance product creation system 100 compares the extracted exclusions to those in the similar policies and available endorsements. This comparison helps identify discrepancies and potential coverage gaps specific to the client's policy.

Based on the comparison, in a fifth step 310, said insurance product creation system 100 generates a checklist of coverage gaps. This checklist can highlight areas where the client's policy lacks coverage compared to similar policies or industry standards.

Finally, in a sixth step 312, said insurance product creation system 100 outputs suggested endorsements to address the identified coverage gaps. These suggestions can be tailored to the client's specific needs and the gaps identified in their policy.

This method provides a systematic approach to ensuring comprehensive insurance coverage for clients.

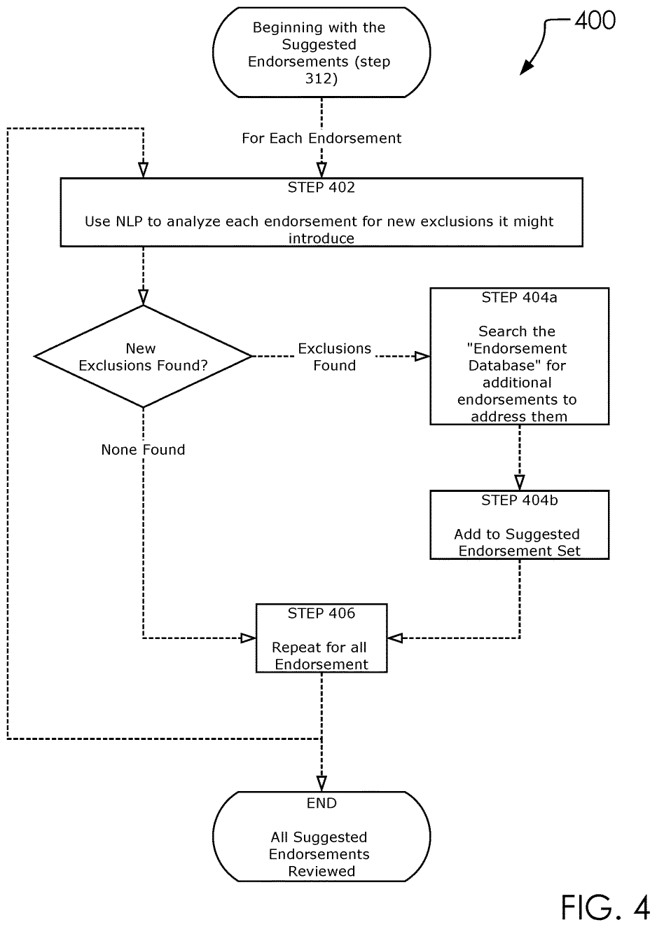

FIG. 4 illustrates a flowchart 400 of the recursive analysis process for suggested endorsements.

The process begins with the endorsement suggestion list 214 generated in said sixth step 312 of the main method. For each endorsement in said endorsement suggestion list 214, said insurance product creation system 100 performs a first step 402, where it uses NLP to analyze the endorsement for any new exclusions it might introduce. This analysis ensures that the suggested endorsements do not create additional coverage gaps.

If new exclusions are found, in a second step 404a, said insurance product creation system 100 searches the endorsement database 122 for additional endorsements that can address these new exclusions. Said endorsement database 122 contains a collection of available endorsements that can be used to modify insurance policies. In a third step 404b, said insurance product creation system 100 adds these additional endorsements to the set of suggested endorsements. This step expands the set to include endorsements that address both the original coverage gaps and any new exclusions introduced by previous endorsements.

The process then repeats this process for all endorsements in the set, as indicated in a fourth step 406. This recursive analysis continues until all suggested endorsements have been reviewed and no new exclusions are introduced. Once all endorsements have been processed, said insurance product creation system 100 can output the final set of suggested endorsements, ensuring comprehensive coverage.

This iterative approach enhances the system's ability to provide thorough and effective insurance solutions.

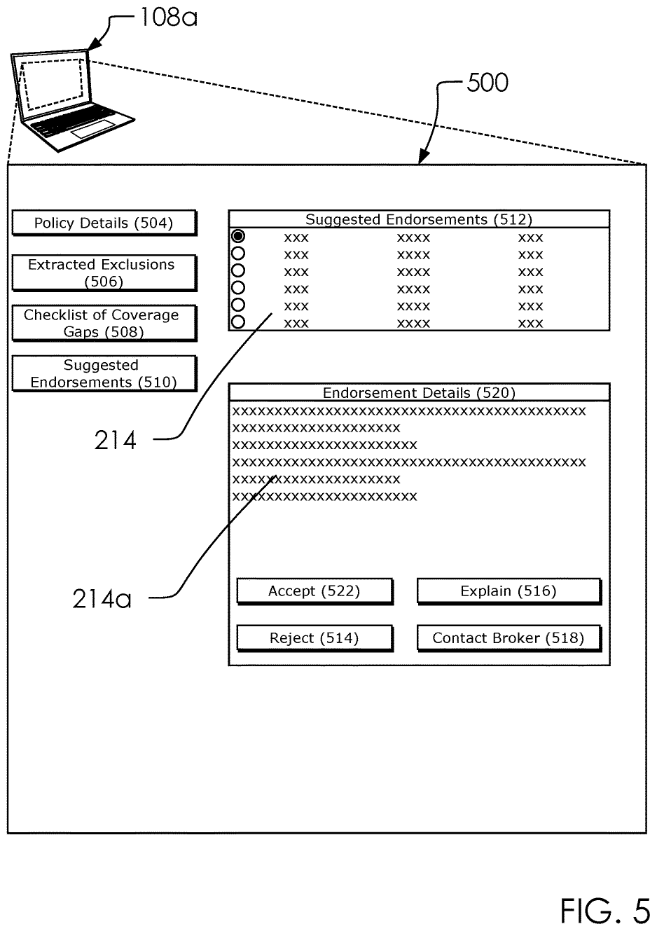

FIG. 5 illustrates the user interface 500 for presenting the checklist and endorsements to the user.

In one embodiment, said user interface 500 can be part of said policyholder application 116a or said agency application 116b, accessible to said agent 102b. Said user interface 500 can display said checklist of coverage gaps 212 and said endorsement suggestion list 214 in a clear and organized manner. For example, the checklist can be presented as a list or table, highlighting each coverage gap with a brief description. Similarly, the suggested endorsements can be listed with explanations of how they address the identified gaps.

Said user interface 500 can also include interactive elements, such as buttons or links, allowing the agent to accept, modify, or reject the suggested endorsements. Additionally, the interface can provide options to contact brokers or access further details about the endorsements. This user-friendly presentation ensures that insurance agents can easily understand and act upon the system's recommendations. Shown in the user interface 500 are navigation options: a policy details button 504, an extracted exclusions button 506, a checklist of coverage gaps button 508, and a suggested endorsements button 510. Also shown are a suggested endorsements selection list 512 showing a portion of said endorsement suggestion list 214, and an endorsement details view 520 showing an endorsement suggestion list 214a.

As further shown in FIG. 5, said endorsement details view 520 includes a set of action controls associated with said endorsement suggestion list 214a, comprising an accept control 522, a reject control 514, an explain control 516, and a contact broker control 518.

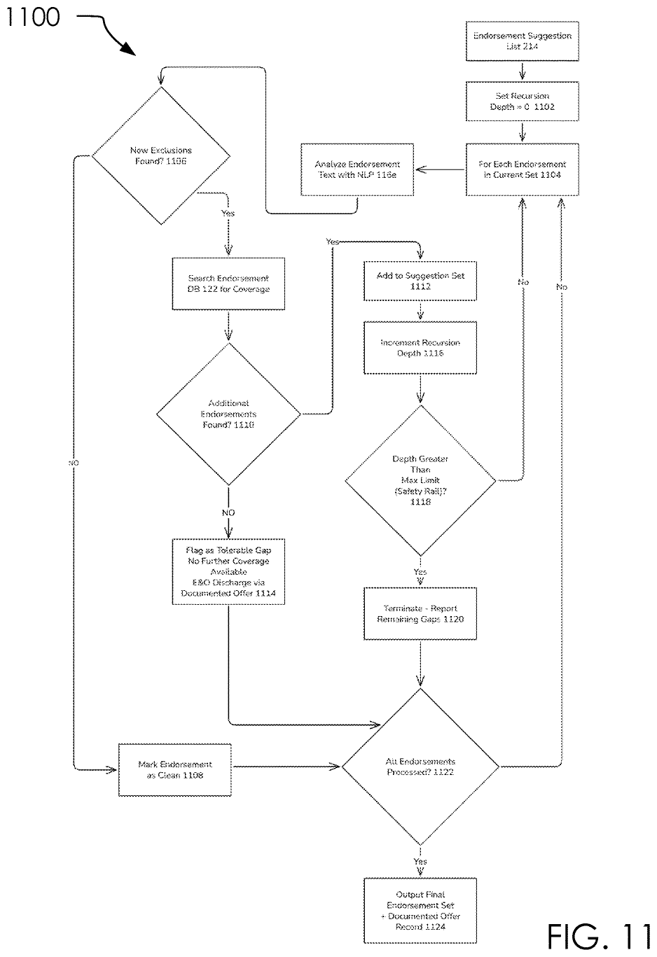

In one embodiment, activation of said accept control 522 by said agent 102b can cause said insurance product creation system 100 to generate an endorsement request routed to said broker computer 108d and to record the acceptance in an offered-coverage audit record 530 introduced with respect to FIG. 11. In one embodiment, activation of said reject control 514 can cause said insurance product creation system 100 to log the rejection in said offered-coverage audit record 530 and to advance the user interface 500 to the next entry in said suggested endorsements selection list 512; the rejection log can preserve the fact that the endorsement was offered to the agent 102b for transmission to a client, supporting the agent's E&O posture even where the endorsement is not ultimately purchased. In one embodiment, activation of said explain control 516 can cause said NLP application 116e to generate a plain-language rationale describing why the endorsement suggestion list 214a was suggested with reference to a specific exclusion among said one or more exclusions 204, and to display the rationale within said endorsement details view 520. In one embodiment, activation of said contact broker control 518 can open a direct communication channel from the agent computer 108b to the broker computer 108d for endorsement quoting and binding.

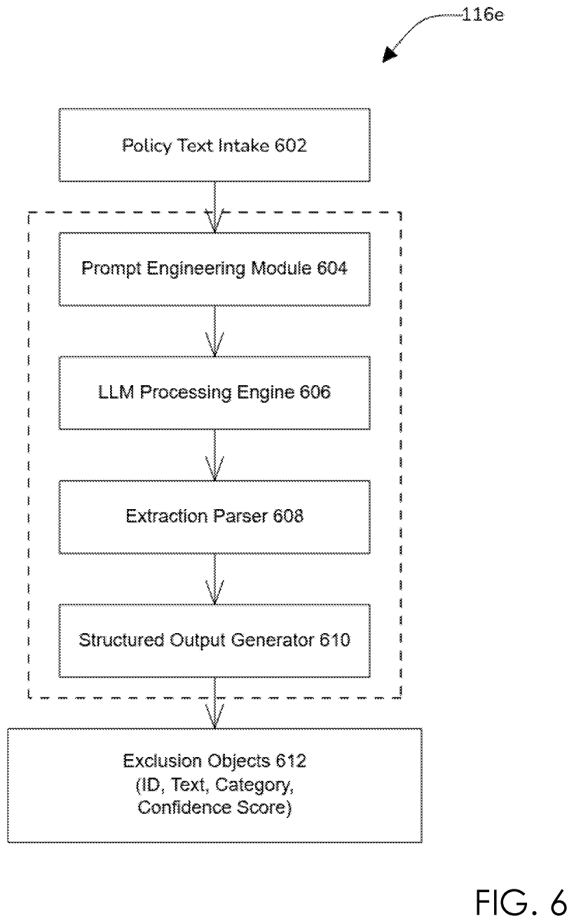

FIG. 6 illustrates a block diagram of an internal software architecture of said NLP application 116e.

Wherein, the pipeline structure of FIG. 6 corresponds to the sequence of software operations carried out within said NLP application 116e when said NLP application 116e is invoked from said policy application 116c of FIG. 2.

Whereas the prior figures describe said NLP application 116e functionally—as a component that “uses natural language processing” to extract exclusions—Figure 6 details one embodiment of the internal pipeline by which the NLP processing is performed.

In one embodiment, said NLP application 116e can comprise a policy text intake 602, a prompt engineering module 604, the LLM processing engine 606, an extraction parser 608, a structured output generator 610, and a set of exclusion objects 612. These components operate as an ordered software pipeline.

Said policy text intake 602 is a software stage that receives the policy text portion of said policy request 202 from said policy application 116c (for example, by way of an in-process function call or an inter-process message). The policy text may be supplied in any of several formats, including without limitation a portable document format (PDF) file, an output of an optical character recognition (OCR) operation performed on a scanned policy document, a plain text representation of a policy, or a structured representation (such as XML or JSON) of a policy whose textual fields are to be analyzed. In one embodiment, said policy text intake 602 can include preprocessing logic that normalizes formatting artifacts (such as page headers, footers, and pagination markers) prior to handoff to the next stage. Said policy text intake 602 is not a user-facing input field; said agent 102b supplies the policy text to said insurance product creation system 100 by way of said user interface 500 of FIG. 5, and said policy application 116c forwards the supplied policy text to said policy text intake 602 internally.

Said prompt engineering module 604 constructs a prompt to be submitted to said LLM processing engine 606. The prompt can comprise (i) a set of extraction instructions specifying the categories of information to be extracted from the policy (for example, exclusion clauses, conditional exclusions, exceptions to exclusions, and references to coverage caps), (ii) a specification of the desired output format (for example, a JSON schema describing each exclusion object), and (iii) the policy text supplied by said policy text intake 602 or a section thereof. In one embodiment, said prompt engineering module 604 can apply chunking logic to divide a long policy into sections of bounded length suitable for the context window of said LLM processing engine 606, and can include in the prompt few-shot examples of correctly extracted exclusions to improve extraction accuracy.

Said LLM processing engine 606 receives the prompt prepared by said prompt engineering module 604 and submits it to a generative artificial intelligence model. In one embodiment, said LLM processing engine 606 can comprise a large language model (LLM) operated locally or accessed through an application programming interface (API) of a third-party LLM provider. The LLM returns a textual response that purports to be a structured representation of the exclusions found in the policy text.

Said extraction parser 608 receives the textual response of said LLM processing engine 606 and parses it according to the output format specified by said prompt engineering module 604. In one embodiment, said extraction parser 608 can validate the parsed output against a JSON schema and can apply repair logic where the LLM response is malformed (for example, by re-prompting the LLM with the malformed output and a request to correct it).

Said structured output generator 610 receives the parsed output of said extraction parser 608 and assembles a set of said exclusion objects 612. Each of said exclusion objects 612 can comprise (i) an exclusion identifier uniquely identifying the exclusion within the analyzed policy, (ii) an exclusion text reproducing or summarizing the language of the exclusion as found in the policy, (iii) a coverage category classifying the exclusion against an industry taxonomy of coverage types, and (iv) a confidence score indicating the LLM's reported confidence in the extraction. The set of said exclusion objects 612 constitutes said one or more exclusions 204 referenced by other figures of this disclosure.

Although FIG. 6 illustrates the components of said NLP application 116e as a linear pipeline, in other embodiments, the order of operations can be varied, two or more of the illustrated components can be combined into a single component, or one or more of the illustrated components can be omitted, depending on implementation requirements. For example, said prompt engineering module 604 and said LLM processing engine 606 can be implemented as a single component where the LLM is fine-tuned on insurance-policy-extraction tasks, in which case the explicit prompt-engineering stage may be reduced or eliminated.

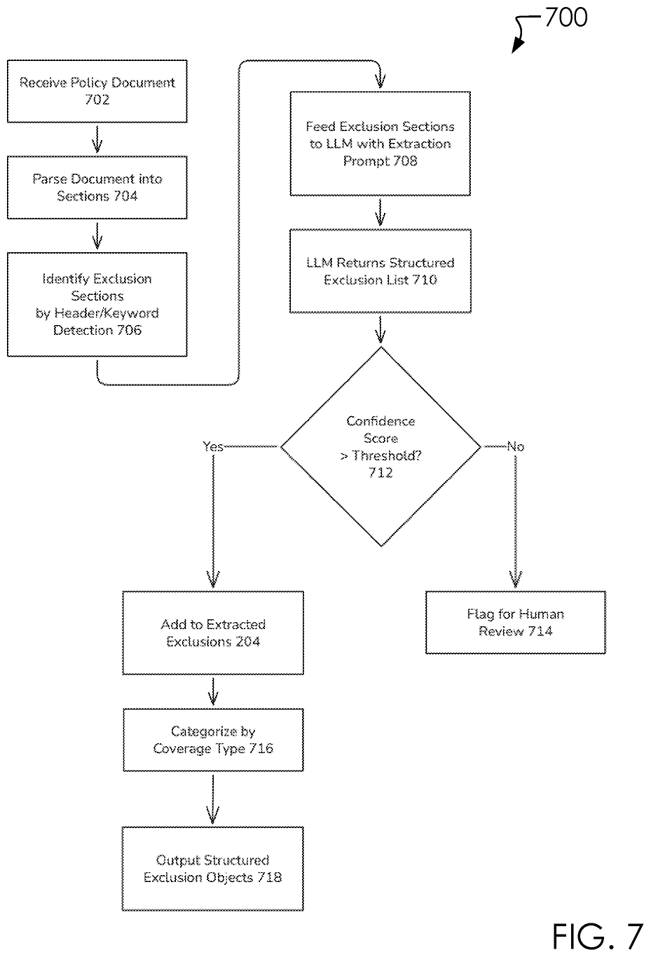

FIG. 7 illustrates a flowchart 700 of an exclusion extraction method performed by said NLP application 116e on an insurance policy document.

The method of flowchart 700 expands upon said second step 304 of the flowchart 300, detailing the substeps by which exclusions are extracted from received policy data.

In a first step 702, said insurance product creation system 100 receives the policy document, for example as part of said policy request 202. The policy document can be a complete insurance policy in one of the formats described above with respect to said policy text intake 602.

In a second step 704, said NLP application 116e parses the policy document into sections. In one embodiment, the parsing can be performed by detecting structural markers within the policy document (such as section headings, numbered clauses, and indentation patterns) and dividing the document accordingly.

In a third step 706, said NLP application 116e identifies one or more sections of the policy document that contain exclusions. The identification can be performed by header detection (for example, recognition of headings containing the term “EXCLUSIONS” or its equivalents), by keyword detection (for example, recognition of phrases such as “this policy does not cover,” “we do not pay for,” or “this insurance does not apply to”), or by a combination of both. In one embodiment, said third step 706 can also perform header- or keyword-based identification of related sections (such as “Conditions,” “Limitations,” and “Exceptions”) that may contain language operating as de facto exclusions.

In a fourth step 708, said NLP application 116e feeds the identified exclusion sections to said LLM processing engine 606 of FIG. 6 by way of a prompt prepared by said prompt engineering module 604 of FIG. 6. The prompt instructs said LLM processing engine 606 to extract each exclusion as a discrete item conforming to a specified output format.

In a fifth step 710, said LLM processing engine 606 returns a structured exclusion list to said extraction parser 608 of FIG. 6. The structured exclusion list can comprise a sequence of candidate exclusion objects, each candidate exclusion object including the data fields described above with respect to said exclusion objects 612 of FIG. 6.

In a sixth step 712, said NLP application 116e applies a confidence-score filter to each candidate exclusion object. Each candidate exclusion object having a confidence score that meets or exceeds a predetermined threshold proceeds to an eighth step 716; each candidate exclusion object having a confidence score below the threshold proceeds to a seventh step 714.

In said seventh step 714, the candidate exclusion object is flagged for human review. In one embodiment, candidate exclusion objects flagged at said seventh step 714 can be presented to said agent 102b through said user interface 500 for manual confirmation, modification, or rejection before being added to said one or more exclusions 204.

In said eighth step 716, said NLP application 116e categorizes each above-threshold candidate exclusion object by coverage type, mapping the candidate's exclusion text to a coverage category drawn from an industry taxonomy. The categorization can be performed by said LLM processing engine 606 in a separate prompt, by a deterministic rules engine operating on the exclusion text, or by a combination of the two.

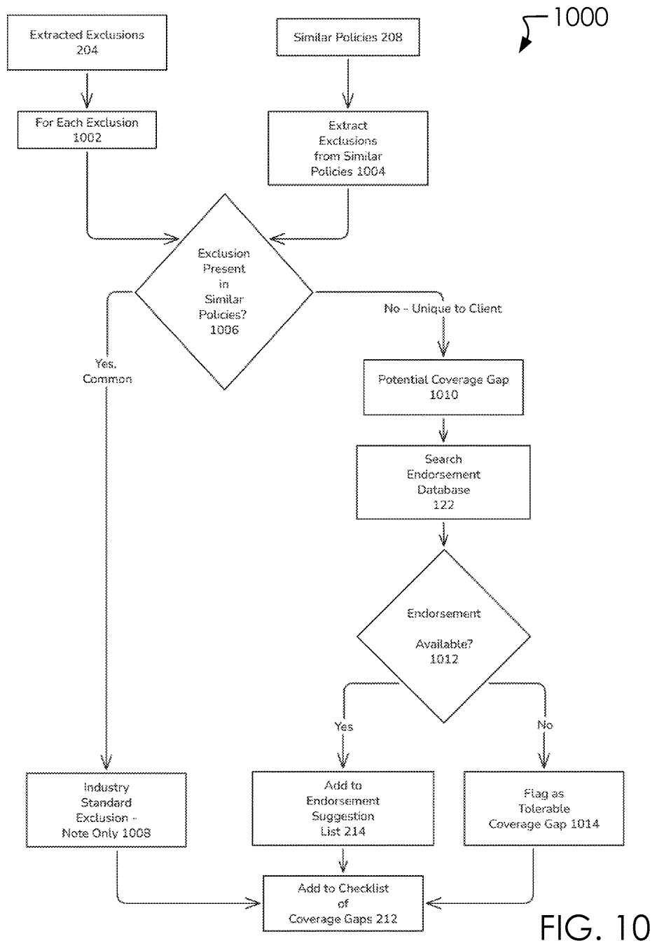

In a ninth step 718, said NLP application 116 e outputs the resulting set of categorized, threshold-passing exclusion objects as said one or more exclusions 204 for use by the comparison process described with respect to FIG. 10.

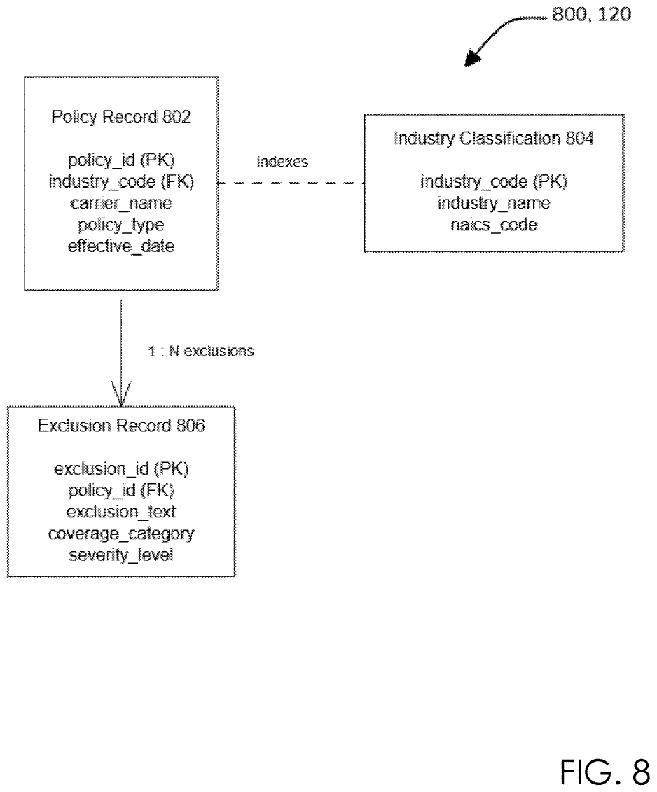

FIG. 8 illustrates a data architecture 800 of said policy database 120.

The data architecture is presented as a logical schema; said policy database 120 can be implemented in any of several physical storage technologies, including without limitation a relational database management system, a document-oriented database, a graph database, or a combination thereof. As noted elsewhere herein, said policy database 120 is described as the data architecture that said insurance product creation system 100 is designed to consume; the contents of said policy database 120 (the corpus of policies) are populated by the operator of the system and are not themselves a feature of the present disclosure.

Said policy database 120 can comprise a collection of policy records 802, a collection of industry classification records 804, and a collection of exclusion records 806.

Each of said policy records 802 can comprise a policy identifier serving as a primary key, an industry code serving as a foreign key into said industry classification records 804, a carrier name identifying the issuing insurer, a policy type identifying the line of coverage (for example, general liability, professional liability, commercial property, or workers' compensation), and an effective date.

Each of said industry classification records 804 can comprise an industry code serving as a primary key, an industry name (for example, “plumbing contractor” or “fireworks vendor”), and a corresponding standardized industry code such as a North American Industry Classification System (NAICS) code. The use of a standardized industry code permits said insurance product creation system 100 to interoperate with external industry-classification systems and to retrieve similar policies 208 for a given client based on the client's standardized industry classification.

Each of said exclusion records 806 can comprise an exclusion identifier serving as a primary key, a policy identifier serving as a foreign key into said policy records 802, an exclusion text reproducing the language of the exclusion as found in the policy, a coverage category classifying the exclusion, and a severity level indicating the relative importance of the exclusion to the overall coverage profile of the policy.

In the architecture illustrated by FIG. 8, each of said policy records 802 can be associated with one or more of said exclusion records 806 (a one-to-many relationship), and each of said industry classification records 804 can index one or more of said policy records 802 (a one-to-many relationship). The system can therefore retrieve, for a given industry, the set of policies categorized under that industry, and for a given policy, the set of exclusions associated with that policy.

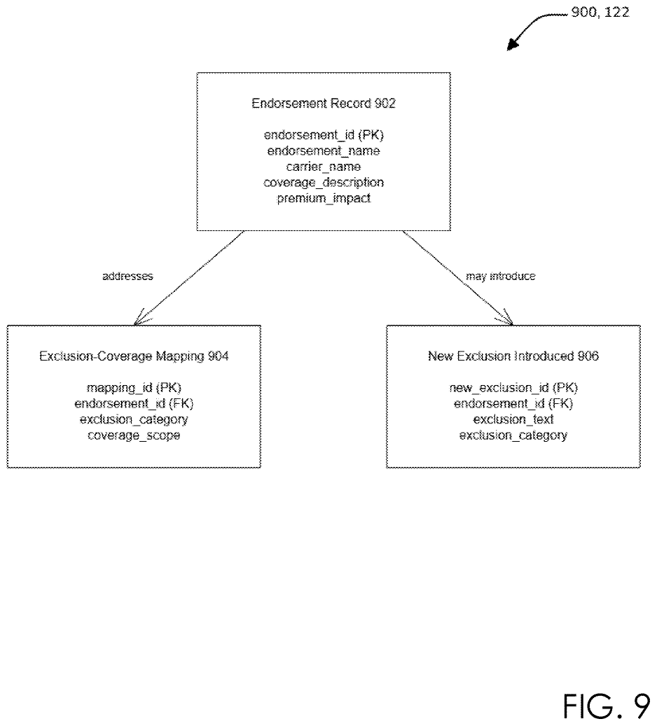

FIG. 9 illustrates a data architecture 900 of said endorsement database 122.

As with said policy database 120, the data architecture of said endorsement database 122 is presented as a logical schema; said endorsement database 122 can be implemented in any suitable storage technology, and the contents of said endorsement database 122 are populated by the operator of the system and are not themselves a feature of the present disclosure.

In one embodiment, said endorsement database 122 is structured as a peer repository to said policy database 120, the two databases together forming the coverage-data substrate against which said insurance product creation system 100 reasons about a client's policy. Said endorsement database 122 can comprise a collection of endorsement record 902, a collection of exclusion-coverage mapping record 904, and a collection of new exclusion record 906.

Each of said endorsement record 902 can comprise an endorsement identifier serving as a primary key, an endorsement name, a carrier name, a coverage description summarizing the additional coverage afforded by the endorsement, and a premium impact indicating the typical incremental premium associated with adding the endorsement to a policy.

Each of said exclusion-coverage mapping record 904 can comprise a mapping identifier serving as a primary key, an endorsement identifier serving as a foreign key into said endorsement record 902, an exclusion category identifying the category of exclusion that the endorsement addresses (corresponding to the coverage category fields in said exclusion records 806 and said exclusion objects 612), and a coverage scope indicating the extent to which the endorsement closes the corresponding coverage gap (for example, full restoration of coverage, partial restoration, or restoration subject to additional sub-limits).

Each of said new exclusion record 906 can comprise a new exclusion identifier serving as a primary key, an endorsement identifier serving as a foreign key into said endorsement record 902, an exclusion text describing a new exclusion that the endorsement itself introduces (an “exclusion within an endorsement”), and an exclusion category for the new exclusion. The presence of said new exclusion record 906 reflects the practical reality that endorsements—while expanding coverage in one respect—frequently impose their own narrower exclusions, which is the basis for the recursive analysis described with respect to FIG. 11.

The relationships in the architecture illustrated by FIG. 9 permit said insurance product creation system 100 to query, for a given exclusion category found in a client's policy, the set of endorsements available to address that category, and for each such endorsement, the set of new exclusions (if any) that the endorsement would itself introduce.

FIG. 10 illustrates a flowchart 1000 of a comparison process performed at said fourth step 308 of the flowchart 300.

The method of flowchart 1000 details how the one or more exclusions 204 extracted from a client's policy are compared against the exclusions found in similar policies 208 and against the available endorsements catalogued in said endorsement database 122 to produce said checklist of coverage gaps 212 and said endorsement suggestion list 214.

The process begins with said one or more exclusions 204 (output of said second step 304 of the flowchart 300) and said similar policies 208 (output of said third step 306 of the flowchart 300).

In a first step 1002, said insurance product creation system 100 iterates over each exclusion in said one or more exclusions 204. In a second step 1004, said insurance product creation system 100 extracts the exclusions from each of said similar policies 208, producing a set of comparison exclusions. The extraction at said second step 1004 can reuse said NLP application 116e following the method of FIG. 7, or can rely on previously extracted exclusions cached in said policy database 120 (for example, in said exclusion records 806).

In a third step 1006, said insurance product creation system 100 determines, for each exclusion under iteration, whether the exclusion is also present in said similar policies 208. The determination can be performed by exact-match comparison of exclusion text, by semantic similarity comparison using vector embeddings of the exclusion text, by a structured comparison of coverage categories, by a prompt-based comparison submitted to said LLM processing engine 606 of FIG. 6, or by a combination of these techniques. In one embodiment, an exclusion is treated as “present” in a similar policy when the semantic similarity between the client-policy exclusion and a similar-policy exclusion meets or exceeds a predetermined similarity threshold.

If the exclusion under iteration is present in a sufficient proportion of said similar policies 208 (a “common” or industry-standard exclusion), the process proceeds to a fourth step 1008, where the exclusion is recorded as an industry-standard exclusion that is noted to said agent 102b for awareness but not flagged as a coverage gap unique to the client.

If the exclusion under iteration is not present in said similar policies 208, or is present in fewer than a predetermined proportion of said similar policies 208, the process proceeds to a fifth step 1010, where the exclusion is treated as a potential coverage gap. From said fifth step 1010, said insurance product creation system 100 queries said endorsement database 122 for endorsements addressing the coverage category of the exclusion, by way of said exclusion-coverage mapping record 904 of FIG. 9.

In a sixth step 1012, said insurance product creation system 100 determines whether at least one endorsement addressing the exclusion is available in said endorsement database 122. If so, the endorsement is added to said endorsement suggestion list 214. If not, the process proceeds to a seventh step 1014, where the exclusion is flagged as a tolerable coverage gap—tolerable in the E&O sense described in the Background and elaborated with respect to FIG. 11.

For each exclusion processed by the loop, said insurance product creation system 100 adds an entry to said checklist of coverage gaps 212 reflecting the disposition of the exclusion: an industry-standard note (from said fourth step 1008), an addressable gap with a corresponding endorsement suggestion (from said sixth step 1012), or a tolerable coverage gap (from said seventh step 1014).

The iteration of said first step 1002 continues until each exclusion in said one or more exclusions 204 has been processed, at which point said checklist of coverage gaps 212 and said endorsement suggestion list 214 are output for use by subsequent steps and by said user interface 500.

FIG. 11 illustrates a flowchart 1100 of the recursive analysis process.

The method of flowchart 1100 expands upon the flowchart 400 of FIG. 4 by detailing three termination conditions, including a primary substantive termination based on exhaustion of available endorsements, and by illustrating the production of an auditable record supporting the agent's E&O posture.

The process begins with said endorsement suggestion list 214 generated by the comparison process of FIG. 10 (or, equivalently, by said sixth step 312 of the flowchart 300).

In a first step 1102, said insurance product creation system 100 initializes a recursion depth counter to zero.

In a second step 1104, said insurance product creation system 100 iterates over each endorsement in the current set of suggested endorsements. For each endorsement under iteration, said insurance product creation system 100 performs an analysis substantially as described with respect to said first step 402 of the flowchart 400, applying said NLP application 116e to the endorsement text to identify any new exclusions introduced by the endorsement.

In a third step 1106, said insurance product creation system 100 determines whether the analysis identified any new exclusions in the endorsement under iteration. If no new exclusions are identified, the process proceeds to a fourth step 1108, where the endorsement under iteration is marked as clean (that is, the endorsement adds coverage without introducing further exclusions to be addressed).

If new exclusions are identified at said third step 1106, said insurance product creation system 100 queries said endorsement database 122 for further endorsements addressing the newly identified exclusions, by way of said exclusion-coverage mapping record 904.

In a fifth step 1110, said insurance product creation system 100 determines whether any such further endorsements are available.

If at least one further endorsement is available at said fifth step 1110, the process proceeds to a sixth step 1112, where each such further endorsement is added to the set of suggested endorsements for processing in a subsequent iteration. From said sixth step 1112, the process proceeds to an eighth step 1116, where the recursion depth counter is incremented, and to a ninth step 1118, where said insurance product creation system 100 determines whether the recursion depth counter has exceeded a predetermined depth limit. The predetermined depth limit functions as a safety rail to prevent unbounded recursion in pathological cases (for example, where the contents of said endorsement database 122 form a circular chain of cross-introducing exclusions); the depth limit is not the substantive terminator of the recursion under normal operation.

If the recursion depth has not exceeded the predetermined limit at said ninth step 1118, the process returns to said second step 1104 for further iteration. If the recursion depth has exceeded the predetermined limit, the process proceeds to a tenth step 1120, where the recursion is terminated and the remaining unaddressed new exclusions are reported as such.

If, at said fifth step 1110, no further endorsement is available to address the newly identified exclusions, the process proceeds to a seventh step 1114. Said seventh step 1114 flags the unaddressable new exclusions as tolerable coverage gaps, on the basis that the marketplace offers no further coverage for those exclusions and that the agent's documented offer of every available endorsement (as captured in the offered-coverage audit record introduced below) discharges the agent's E&O obligation in respect of those remaining gaps. Said seventh step 1114 is the primary substantive termination condition of the recursive analysis: under normal operation, the recursion terminates not because a depth limit is reached but because the endorsement database 122 contains no further endorsement addressing the remaining exclusions.

In an eleventh step 1122, said insurance product creation system 100 determines whether all endorsements in the current set have been processed. If not, the process returns to said second step 1104 for further iteration. If so, the process proceeds to a twelfth step 1124, where said insurance product creation system 100 outputs (i) a final endorsement set comprising the union of all endorsements added through one or more iterations of said sixth step 1112 and the original endorsements of said endorsement suggestion list 214, and (ii) the offered-coverage audit record 530 reflecting, for each endorsement in the final endorsement set, the disposition of that endorsement (presented to the agent, accepted, rejected, or flagged as a tolerable gap with no further endorsement available). The dual output of said twelfth step 1124 supports two distinct objectives: the final endorsement set drives the recommendations presented to the agent 102b through said user interface 500 of FIG. 5, and said offered-coverage audit record 530 provides the documented record on which the agent's E&O defense rests.

In one embodiment, said offered-coverage audit record 530 is structured as a sequence of audit entries, each audit entry comprising (i) an exclusion identifier corresponding to one of said one or more exclusions 204, (ii) an endorsement identifier identifying the endorsement (if any) suggested to address the exclusion, (iii) a disposition field indicating the outcome (for example: presented-to-agent, accepted-by-client, rejected-by-client, deferred, contact-broker-initiated, or no-endorsement-available), (iv) a timestamp of the disposition, and (v) optionally, a free-text note recording any additional context captured by the agent 102b through said user interface 500. Said offered-coverage audit record 530 can be persisted in any suitable storage substrate associated with said insurance product creation system 100 (for example, in association with said policy management computer 108c), and can be exported as a portable document for inclusion in the client file. The persisted record provides a contemporaneous, machine-generated record of every available endorsement offered, which is the documentary substrate of the agent's E&O defense as described in the Background.

In summary, the recursive analysis of the flowchart 1100 is governed by three termination conditions: (a) at said third step 1106, no new exclusions are identified in any endorsement of the current set, indicating that the chain of analysis has reached a fixed point; (b) at said fifth step 1110, no further endorsement is available in said endorsement database 122 to address the newly identified exclusions, in which case the remaining gaps are tolerable in the E&O sense; and (c) at said ninth step 1118, the recursion depth has exceeded the predetermined safety-rail limit. Conditions (a) and (b) are the substantive terminators encountered in normal operation; condition (c) is a guard against pathological inputs.

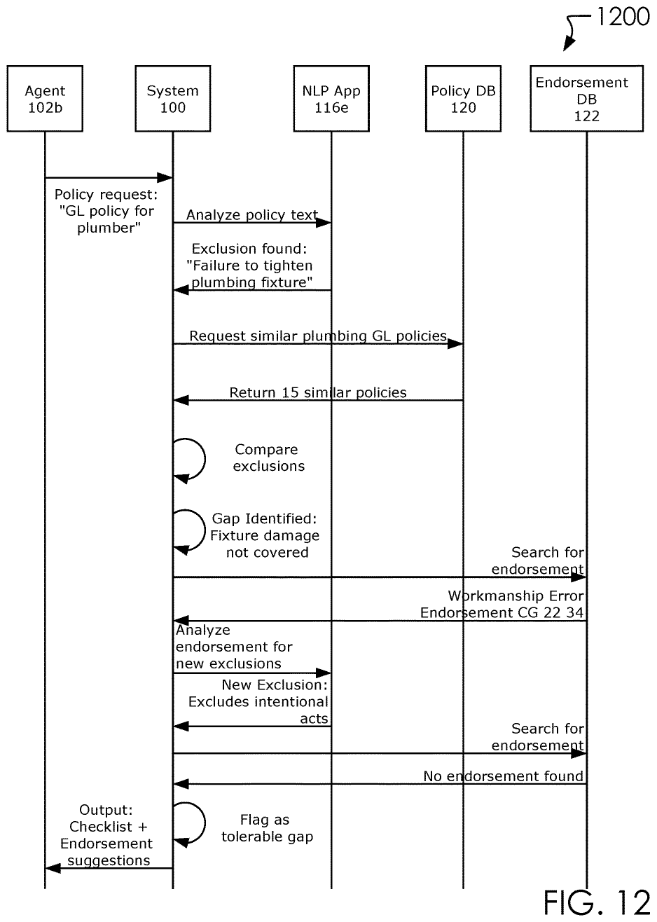

FIG. 12 illustrates an end-to-end example 1200 of operation of said insurance product creation system 100 using a worked plumber-policy scenario consistent with the example developed in the Background.

Said end-to-end example 1200 depicts message exchange among said agent 102b, said insurance product creation system 100 (collectively, “System”), said NLP application 116e, said policy database 120, and said endorsement database 122. The example is non-limiting and is provided for the purpose of illustrating the cooperation of the components and methods described with respect to the preceding figures.

Said end-to-end example 1200 can be understood as one method of use of said insurance product creation system 100.

In a first interaction, said agent 102b submits to said insurance product creation system 100 the policy request 202 for a general liability policy for a plumbing contractor.

Said insurance product creation system 100 forwards the policy text of the policy request 202 to said NLP application 116e for analysis according to the methods of FIGS. 6 and 7. Said NLP application 116e returns to said insurance product creation system 100 a set of one or more exclusions 204 including, by way of example, an exclusion for “damage arising from failure to tighten a plumbing fixture.”

Said insurance product creation system 100 queries said policy database 120 for similar plumbing-contractor general-liability policies, by way of the architecture of FIG. 8. Said policy database 120 returns a set of similar policies 208 (for example, fifteen similar policies sharing the client's industry classification).

Said insurance product creation system 100 performs the comparison process of FIG. 10 against the one or more exclusions 204 and the similar policies 208, identifying that the exclusion for “damage arising from failure to tighten a plumbing fixture” is not commonly present among the similar policies 208 and therefore constitutes a potential coverage gap unique to the client's policy.

Said insurance product creation system 100 queries said endorsement database 122 (by way of the architecture of FIG. 9) for an endorsement addressing the identified coverage gap. Said endorsement database 122 returns an endorsement, identified by way of example as “Workmanship Error Endorsement CG 22 34,” and said insurance product creation system 100 adds the returned endorsement to said endorsement suggestion list 214.

Said insurance product creation system 100 then performs the recursive analysis of FIG. 11 against the returned endorsement. Said NLP application 116e analyzes the text of the “Workmanship Error Endorsement CG 22 34” and identifies a new exclusion introduced by that endorsement: by way of example, an exclusion for “intentional acts.”

Said insurance product creation system 100 queries said endorsement database 122 for an endorsement addressing the newly identified “intentional acts” exclusion. In the present example, said endorsement database 122 returns no further endorsement available to address the “intentional acts” exclusion. Pursuant to said seventh step 1114 of the flowchart 1100, said insurance product creation system 100 flags the “intentional acts” exclusion as a tolerable coverage gap and records that flagging in said offered-coverage audit record 530.

Said insurance product creation system 100 outputs to said agent 102b, by way of said user interface 500, (i) said checklist of coverage gaps 212 enumerating the identified coverage gaps and tolerable gaps, (ii) said endorsement suggestion list 214 including “Workmanship Error Endorsement CG 22 34” as the suggested endorsement, and (iii) the contents of said offered-coverage audit record 530 documenting the analysis path and the disposition of each identified exclusion. Said agent 102b can then present the recommended endorsement to the client by way of said user interface 500 (using, for example, said accept control 522, said explain control 516, or said contact broker control 518 of FIG. 5), with the assurance that the documented offer record discharges the agent's E&O obligation in respect of the tolerable gap regardless of whether the client elects to purchase the recommended endorsement.

The example of FIG. 12 illustrates the cooperation of the architecture of FIG. 1, the data flow of FIG. 2, the main method of FIG. 3, the recursive analysis of FIG. 4, the user interface of FIG. 5, the NLP architecture of FIG. 6, the extraction method of FIG. 7, the data architectures of FIGS. 8 and 9, the comparison process of FIG. 10, and the termination logic of FIG. 11. Variations of the example—including different industries, different exclusion categories, and different recursion depths—will be apparent to those of skill in the art and are within the scope of this disclosure.

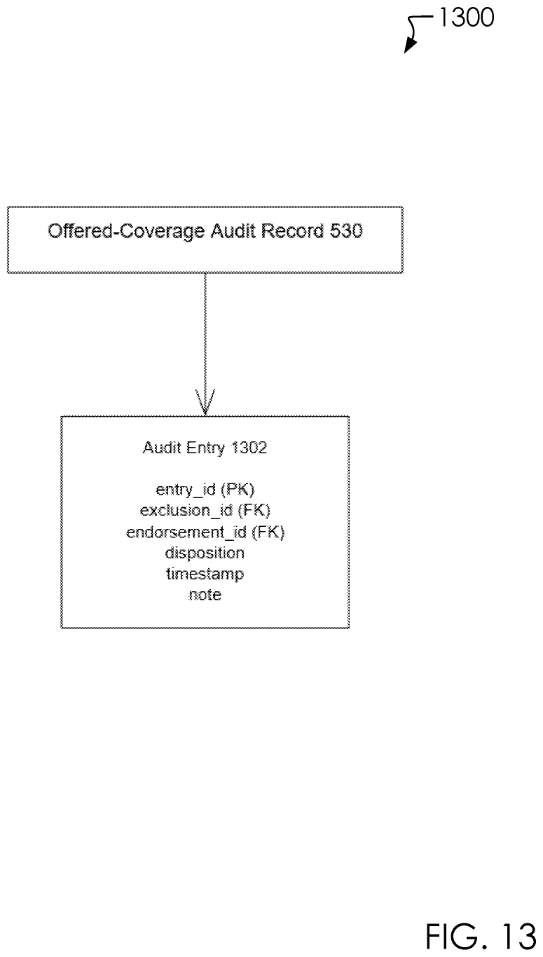

FIG. 13 illustrates an audit record data architecture 1300 of said offered-coverage audit record 530.

In one embodiment, said audit record data architecture 1300 is a logical schema; said offered-coverage audit record 530 can be implemented in any of several physical storage technologies, including without limitation a relational database management system, a document-oriented database, a flat-file append-only log, or a combination thereof. As with said policy database 120 and said endorsement database 122, the contents of said offered-coverage audit record 530 are populated at runtime by said insurance product creation system 100 as it processes requests from said agent 102b; the contents are not themselves a feature of the present disclosure.

In one embodiment, said offered-coverage audit record 530 can comprise a collection of an audit entry 1302. Each of said audit entry 1302 can comprise an entry identifier serving as a primary key, an exclusion identifier serving as a foreign key into said one or more exclusions 204 (identifying which exclusion among the client's policy the entry relates to), an endorsement identifier serving as a foreign key into said endorsement database 122 (identifying which endorsement, if any, was suggested to address the exclusion), a disposition field indicating the outcome of the entry (for example, presented-to-agent, accepted-by-client, rejected-by-client, deferred, contact-broker-initiated, or no-endorsement-available), a timestamp of the disposition, and optionally a free-text note recording any additional context captured by said agent 102b through said user interface 500.

In the architecture illustrated by FIG. 13, said offered-coverage audit record 530 has a one-to-many relationship with said audit entry 1302; a single offered-coverage audit record 530 generated for a single client policy analysis will typically contain one audit entry 1302 for each exclusion identified among said one or more exclusions 204. The disposition field of each audit entry 1302 records the ultimate outcome of the endorsement-offer workflow for the corresponding exclusion, and—taken together across all entries of said offered-coverage audit record 530—the disposition fields constitute the documented record of every available endorsement offered that supports the agent's E&O posture as described in the Background and as produced by said twelfth step 1124 of FIG. 11 (said offered-coverage audit record 530 being one of the two outputs of said twelfth step 1124).

Parts List:
the insurance product creation system 100,
the one or more transaction parties 102,
the policyholder 102a,
the agent 102b,
the broker 102c,
the one or more computers 108,
the policyholder computer 108a,
the agent computer 108b,
the policy management computer 108c,
the broker computer 108d,
the memory 110,
the one or more processors 112,
the network hardware 114,
the one or more applications 116,
the policyholder application 116a,
the agency application 116b,
the policy application 116c,
the broker application 116d,
the NLP application 116e,
the policy database 120,
the endorsement database 122,
the network 130,
the interaction diagram 200,
the policy request 202,
the one or more exclusions 204,
the request for similar policies 206,
the similar policies 208,
the comparison list 210,
the checklist of coverage gaps 212,
the endorsement suggestion list 214,
the endorsement suggestion list 214a,
the flowchart 300,
the first step 302,
the second step 304,
the third step 306,
the fourth step 308,
the fifth step 310,
the sixth step 312,
the flowchart 400,
the first step 402,
the second step 404a,
the third step 404b,
the fourth step 406,
the user interface 500,
the policy details button 504,
the extracted exclusions button 506,
the checklist of coverage gaps button 508,
the suggested endorsements button 510,
the suggested endorsements selection list 512,
the reject control 514,
the explain control 516,
the contact broker control 518,
the endorsement details view 520,
the accept control 522,
the offered-coverage audit record 530,
the policy text intake 602,
the prompt engineering module 604,
the LLM processing engine 606,
the extraction parser 608,
the structured output generator 610,
the exclusion objects 612,
the flowchart 700,
the first step 702,
the second step 704,
the third step 706,
the fourth step 708,
the fifth step 710,
the sixth step 712,
the seventh step 714,
the eighth step 716,
the ninth step 718,
the data architecture 800,
the policy records 802,
the industry classification records 804,
the exclusion records 806,
the data architecture 900,
the endorsement record 902,
the exclusion-coverage mapping record 904,
the new exclusion record 906,
the flowchart 1000,
the first step 1002,
the second step 1004,
the third step 1006,
the fourth step 1008,
the fifth step 1010,
the sixth step 1012,
the seventh step 1014,
the flowchart 1100,
the first step 1102,
the second step 1104,
the third step 1106,
the fourth step 1108,
the fifth step 1110,
the sixth step 1112,
the seventh step 1114,
the eighth step 1116,
the ninth step 1118,
the tenth step 1120,
the eleventh step 1122,
the twelfth step 1124,
the end-to-end example 1200,
the audit record data architecture 1300, and
the audit entry 1302.

The following comprises one preferred embodiment of the disclosure based on the original claims.

The insurance product creation system 100 for identifying and addressing coverage gaps in an insurance policy and for generating an errors-and-omissions discharge record, can comprise one or more computers 108, each comprising the memory 110, one or more processors 112, network hardware 114, and one or more applications 116 stored in the memory 110 and executable by the one or more processors 112. The policy database 120 storing a plurality of insurance policies categorized by industry. The endorsement database 122 storing a plurality of endorsements and, for each endorsement, any new exclusion introduced by the endorsement. Wherein the one or more applications 116, when executed by the one or more processors 112, can be configured to: receive insurance policy data and client information. Extract, by the NLP application 116e of the one or more applications 116, a plurality of exclusion objects 612 from the insurance policy data, each exclusion object of the exclusion objects 612 comprising an exclusion identifier, an exclusion text, a coverage category, and a confidence score. Retrieve, from the policy database 120, a set of similar policies based on an industry classification associated with the client information. Compare each of the exclusion objects 612 against exclusions found in the set of similar policies to identify one or more potential coverage gaps unique to the insurance policy data. Query the endorsement database 122 for each identified potential coverage gap to generate an endorsement suggestion list. Perform a recursive analysis of the endorsement suggestion list by, for each endorsement in the endorsement suggestion list, analyzing the endorsement text using the NLP application 116e to identify any new exclusions introduced by the endorsement and querying the endorsement database 122 for further endorsements addressing the new exclusions, the recursive analysis terminating upon satisfaction of at least one of no new exclusions being identified in the analyzed endorsements, the endorsement database 122 containing no further endorsement addressing remaining new exclusions, and a predetermined recursion-depth limit being reached. Output a final endorsement set, and the offered-coverage audit record 530 comprising, for each of the exclusion objects 612, a recorded disposition of at least one available endorsement offered with respect to the exclusion object.

The one or more computers 108 can be associated with one or more transaction parties 102: the policyholder computer 108a associated with the policyholder 102a, the agent computer 108b associated with the agent 102b, and the broker computer 108d associated with the broker 102c, and the one or more applications 116 further include the policyholder application 116a executable by the policyholder computer 108a, the agency application 116b executable by the agent computer 108b, and the broker application 116d executable by the broker computer 108d.

The NLP application 116e comprises the prompt engineering module 604, the LLM processing engine 606, and the extraction parser 608, and the NLP application 116e can be configured to extract each of the exclusion objects 612 by submitting to the LLM processing engine 606 a prompt constructed by the prompt engineering module 604, the prompt including instructions to extract one or more specified categories of exclusion information, a description of an output format defining a schema for the exclusion objects 612, and at least a section of the insurance policy data.

The LLM processing engine 606 comprises a large language model executed on at least one of hardware locally coupled to one of the one or more computers 108, and a remote computing resource accessed by the one or more processors 112 over the network 130 via an application programming interface.

Each candidate exclusion object having a confidence score below a predetermined threshold can be routed by the one or more applications 116 to a human-review branch prior to being added to the exclusion objects 612.

The comparison of each of the exclusion objects 612 against exclusions found in the set of similar policies can be performed by at least one of exact-match comparison of exclusion text, semantic similarity comparison using vector embeddings of exclusion text, structured comparison of coverage categories, and prompt-based comparison submitted to a large language model.

The endorsement database 122 comprises, for each of the plurality of endorsements, the endorsement record 902 having an endorsement identifier, the exclusion-coverage mapping record 904 linking the endorsement to at least one coverage category addressed by the endorsement, and the new exclusion record 906 identifying any new exclusion introduced by the endorsement.

The offered-coverage audit record 530 can be structured as a sequence of audit entry 1302, each of the audit entry 1302 comprising an entry identifier, an exclusion identifier corresponding to one of the exclusion objects 612, an endorsement identifier, a recorded disposition of the available endorsement offered, and a timestamp, and the recorded disposition has a value selected from a set can comprise presented-to-agent, accepted-by-client, rejected-by-client, deferred, contact-broker-initiated, and no-endorsement-available.

The potential coverage gap for which the endorsement database 122 contains no further endorsement addressing the potential coverage gap can be classified by the one or more applications 116 as a tolerable coverage gap, and the classification of the potential coverage gap as a tolerable coverage gap can be recorded in the offered-coverage audit record 530 to support a documented offer of every available endorsement for purposes of an errors-and-omissions defense of agent 102b.

A method for identifying and addressing coverage gaps in an insurance policy and for generating an errors-and-omissions discharge record, the method being performed by one or more processors 112 of one or more computers 108 operating on data stored in the memory 110 of the one or more computers 108, the method can comprise receiving, by the one or more processors 112, insurance policy data and client information. Extracting, by the NLP application 116e executed by the one or more processors 112, a plurality of exclusion objects 612 from the insurance policy data, each exclusion object of the exclusion objects 612 comprising an exclusion identifier, an exclusion text, a coverage category, and a confidence score. Retrieving, by the one or more processors 112 from the policy database 120, a set of similar policies based on an industry classification associated with the client information. Comparing, by the one or more processors 112, each of the exclusion objects 612 against exclusions found in the set of similar policies to identify one or more potential coverage gaps unique to the insurance policy data. Querying, by the one or more processors 112, the endorsement database 122 for each identified potential coverage gap to generate an endorsement suggestion list. Performing, by the one or more processors 112, a recursive analysis of the endorsement suggestion list, the recursive analysis comprising iteratively analyzing each endorsement in the endorsement suggestion list for any new exclusion introduced by the endorsement and querying the endorsement database 122 for further endorsements addressing the new exclusion, the recursive analysis terminating when the endorsement database 122 contains no further endorsement capable of addressing a remaining new exclusion. Generating, by the one or more processors 112, the offered-coverage audit record 530 documenting, for each of the exclusion objects 612, a recorded disposition of at least one available endorsement offered with respect to the exclusion object, the offered-coverage audit record 530 serving as a record of every available endorsement offered with respect to the insurance policy for purposes of discharging an errors-and-omissions obligation of an insurance agent.

The recursive analysis further terminates upon reaching a predetermined recursion-depth limit, the predetermined recursion-depth limit operating as a safety rail against unbounded recursion, and under normal operation the recursive analysis terminates based on the endorsement database 122 containing no further endorsement capable of addressing the remaining new exclusion rather than based on the predetermined recursion-depth limit.

The extracting of the plurality of exclusion objects 612 comprises parsing the insurance policy data into sections, identifying one or more sections of the insurance policy data that contain exclusions by at least one of header detection and keyword detection, submitting the identified one or more sections to a large language model by way of a prompt that includes instructions to extract one or more specified categories of exclusion information and a description of an output format defining a schema for the exclusion objects 612, and parsing a structured response returned by the large language model against the schema to produce the plurality of exclusion objects 612.

Classifying each of the exclusion objects 612 as one of an industry-standard exclusion where the exclusion appears in at least a predetermined proportion of the set of similar policies, and a client-unique coverage gap otherwise, and recording only the client-unique coverage gaps in the offered-coverage audit record 530 as coverage gaps while recording the industry-standard exclusions as informational entries.

Classifying a potential coverage gap as a tolerable coverage gap when the endorsement database 122 contains no further endorsement addressing the potential coverage gap, and recording the classification in the offered-coverage audit record 530 together with an identifier of the potential coverage gap.

The offered-coverage audit record 530 comprises, for each of the exclusion objects 612, a recorded disposition having a value selected from a set can comprise presented-to-agent, accepted-by-client, rejected-by-client, deferred, contact-broker-initiated, and no-endorsement-available, and the offered-coverage audit record 530 can be exportable as a portable document for inclusion in a client file.

The NLP application 116e for extracting exclusions from an insurance policy, the apparatus can comprise one or more processors 112. The memory 110 coupled to the one or more processors 112, the memory 110 storing instructions that, when executed by the one or more processors 112, cause the apparatus to: receive insurance policy text. Construct, by the prompt engineering module 604 of the apparatus, a prompt comprising extraction instructions specifying one or more categories of exclusion information to be extracted, an output format specification defining a structured exclusion object schema, and at least a section of the insurance policy text. Submit the prompt to the LLM processing engine 606 of the apparatus and receive a textual response from the LLM processing engine 606. Parse, by the extraction parser 608 of the apparatus, the textual response against the output format specification to produce a plurality of candidate exclusion objects, each candidate exclusion object comprising an exclusion identifier, an exclusion text, a coverage category, and a confidence score. Filter the plurality of candidate exclusion objects by comparing each candidate exclusion object's confidence score against a predetermined threshold. Output the filtered candidate exclusion objects as a set of exclusion objects 612 for use by a coverage-gap analysis system.

The instructions further cause the apparatus to divide the insurance policy text into a plurality of sections of bounded length prior to constructing the prompt, and to include in the prompt only one of the plurality of sections at a time such that the one of the plurality of sections can be of a length suitable for a context window of the LLM processing engine 606. The LLM processing engine 606 can be accessed by the one or more processors 112 via an application programming interface over the network 130 coupled to the network hardware 114 of the apparatus.

Parsing the textual response comprises validating the textual response against a predetermined schema and, upon detecting that the textual response does not satisfy the predetermined schema, re-prompting the LLM processing engine 606 with an indication of a malformed-output condition to obtain a replacement textual response.

Each candidate exclusion object having a confidence score below the predetermined threshold can be flagged for human review through a user interface prior to being excluded from the set of exclusion objects 612.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. An insurance product creation system for identifying and addressing coverage gaps in an insurance policy and for generating an errors-and-omissions discharge record, comprising:
one or more computers, each comprising a memory, one or more processors, network hardware, and one or more applications stored in the memory and executable by the one or more processors;
a policy database storing a plurality of insurance policies categorized by industry;
an endorsement database storing a plurality of endorsements and, for each endorsement, any new exclusion introduced by the endorsement; and
wherein the one or more applications, when executed by the one or more processors, are configured to:
receive insurance policy data and client information;
extract, by a NLP application of the one or more applications, a plurality of exclusion objects from the insurance policy data, each exclusion object of the exclusion objects comprising an exclusion identifier, an exclusion text, a coverage category, and a confidence score;
retrieve, from the policy database, a set of similar policies based on an industry classification associated with the client information;
compare each of the exclusion objects against exclusions found in the set of similar policies to identify one or more potential coverage gaps unique to the insurance policy data;
query the endorsement database for each identified potential coverage gap to generate an endorsement suggestion list;
perform a recursive analysis of the endorsement suggestion list by, for each endorsement in the endorsement suggestion list, analyzing the endorsement text using the NLP application to identify any new exclusions introduced by the endorsement and querying the endorsement database for further endorsements addressing the new exclusions, the recursive analysis terminating upon satisfaction of at least one of
no new exclusions being identified in the analyzed endorsements,
the endorsement database containing no further endorsement addressing remaining new exclusions, and
a predetermined recursion-depth limit being reached; and
output
a final endorsement set, and
an offered-coverage audit record comprising, for each of the exclusion objects, a recorded disposition of at least one available endorsement offered with respect to the exclusion object.

2. The insurance product creation system of claim 1, wherein
the one or more computers are associated with one or more transaction parties:
a policyholder computer associated with a policyholder,
an agent computer associated with an agent, and
a broker computer associated with a broker, and
the one or more applications further include
a policyholder application executable by the policyholder computer,
an agency application executable by the agent computer, and
a broker application executable by the broker computer.

3. The insurance product creation system of claim 1, wherein
a NLP application comprises
a prompt engineering module,
a LLM processing engine, and
an extraction parser, and
the NLP application is configured to extract each of the exclusion objects by submitting to the LLM processing engine a prompt constructed by the prompt engineering module, the prompt including
instructions to extract one or more specified categories of exclusion information,
a description of an output format defining a schema for the exclusion objects, and
at least a section of the insurance policy data.

4. The insurance product creation system of claim 3, wherein
the LLM processing engine comprises a large language model executed on at least one of
hardware locally coupled to one of the one or more computers, and
a remote computing resource accessed by the one or more processors over a network via an application programming interface.

5. The insurance product creation system of claim 1, wherein
each candidate exclusion object having a confidence score below a predetermined threshold is routed by the one or more applications to a human-review branch prior to being added to the exclusion objects.

6. The insurance product creation system of claim 1, wherein
the comparison of each of the exclusion objects against exclusions found in the set of similar policies is performed by at least one of
exact-match comparison of exclusion text,
semantic similarity comparison using vector embeddings of exclusion text,
structured comparison of coverage categories, and
prompt-based comparison submitted to a large language model.

7. The insurance product creation system of claim 1, wherein
the endorsement database comprises, for each of the plurality of endorsements,
an endorsement record having an endorsement identifier,
an exclusion-coverage mapping record linking the endorsement to at least one coverage category addressed by the endorsement, and
a new exclusion record identifying any new exclusion introduced by the endorsement.

8. The insurance product creation system of claim 1, wherein
the offered-coverage audit record is structured as a sequence of audit entry, each of the audit entry comprising an entry identifier, an exclusion identifier corresponding to one of the exclusion objects, an endorsement identifier, a recorded disposition of the available endorsement offered, and a timestamp, and
the recorded disposition has a value selected from a set comprising: presented-to-agent, accepted-by-client, rejected-by-client, deferred, contact-broker-initiated, and no-endorsement-available.

9. The insurance product creation system of claim 1, wherein
the potential coverage gap for which the endorsement database contains no further endorsement addressing the potential coverage gap is classified by the one or more applications as a tolerable coverage gap, and
the classification of the potential coverage gap as a tolerable coverage gap is recorded in the offered-coverage audit record to support a documented offer of every available endorsement for purposes of an errors-and-omissions defense of agent.

10. A method for identifying and addressing coverage gaps in an insurance policy and for generating an errors-and-omissions discharge record, the method being performed by one or more processors of one or more computers operating on data stored in a memory of the one or more computers, the method comprising:
receiving, by the one or more processors, insurance policy data and client information;
extracting, by a NLP application executed by the one or more processors, a plurality of exclusion objects from the insurance policy data, each exclusion object of the exclusion objects comprising an exclusion identifier, an exclusion text, a coverage category, and a confidence score;
retrieving, by the one or more processors from a policy database, a set of similar policies based on an industry classification associated with the client information;
comparing, by the one or more processors, each of the exclusion objects against exclusions found in the set of similar policies to identify one or more potential coverage gaps unique to the insurance policy data;
querying, by the one or more processors, an endorsement database for each identified potential coverage gap to generate an endorsement suggestion list;
performing, by the one or more processors, a recursive analysis of the endorsement suggestion list, the recursive analysis comprising iteratively analyzing each endorsement in the endorsement suggestion list for any new exclusion introduced by the endorsement and querying the endorsement database for further endorsements addressing the new exclusion, the recursive analysis terminating when the endorsement database contains no further endorsement capable of addressing a remaining new exclusion; and
generating, by the one or more processors, an offered-coverage audit record documenting, for each of the exclusion objects, a recorded disposition of at least one available endorsement offered with respect to the exclusion object, the offered-coverage audit record serving as a record of every available endorsement offered with respect to the insurance policy for purposes of discharging an errors-and-omissions obligation of an insurance agent.

11. The method of claim 10, wherein
the recursive analysis further terminates upon reaching a predetermined recursion-depth limit, the predetermined recursion-depth limit operating as a safety rail against unbounded recursion, and
under normal operation the recursive analysis terminates based on the endorsement database containing no further endorsement capable of addressing the remaining new exclusion rather than based on the predetermined recursion-depth limit.

12. The method of claim 10, wherein
the extracting of the plurality of exclusion objects comprises
parsing the insurance policy data into sections,
identifying one or more sections of the insurance policy data that contain exclusions by at least one of header detection and keyword detection,
submitting the identified one or more sections to a large language model by way of a prompt that includes instructions to extract one or more specified categories of exclusion information and a description of an output format defining a schema for the exclusion objects, and
parsing a structured response returned by the large language model against the schema to produce the plurality of exclusion objects.

13. The method of claim 10, further comprising
classifying each of the exclusion objects as one of
an industry-standard exclusion where the exclusion appears in at least a predetermined proportion of the set of similar policies, and
a client-unique coverage gap otherwise, and
recording only the client-unique coverage gaps in the offered-coverage audit record as coverage gaps while recording the industry-standard exclusions as informational entries.

14. The method of claim 10, further comprising
classifying a potential coverage gap as a tolerable coverage gap when the endorsement database contains no further endorsement addressing the potential coverage gap, and
recording the classification in the offered-coverage audit record together with an identifier of the potential coverage gap.

15. The method of claim 10, wherein
the offered-coverage audit record comprises, for each of the exclusion objects, a recorded disposition having a value selected from a set comprising: presented-to-agent, accepted-by-client, rejected-by-client, deferred, contact-broker-initiated, and no-endorsement-available, and
the offered-coverage audit record is exportable as a portable document for inclusion in a client file.

16. A NLP application for extracting exclusions from an insurance policy, the apparatus comprising:
one or more processors;
a memory coupled to the one or more processors, the memory storing instructions that, when executed by the one or more processors, cause the apparatus to:
receive insurance policy text;
construct, by a prompt engineering module of the apparatus, a prompt comprising
extraction instructions specifying one or more categories of exclusion information to be extracted,
an output format specification defining a structured exclusion object schema, and
at least a section of the insurance policy text;
submit the prompt to a LLM processing engine of the apparatus and receive a textual response from the LLM processing engine;
parse, by an extraction parser of the apparatus, the textual response against the output format specification to produce a plurality of candidate exclusion objects, each candidate exclusion object comprising an exclusion identifier, an exclusion text, a coverage category, and a confidence score;
filter the plurality of candidate exclusion objects by comparing each candidate exclusion object's confidence score against a predetermined threshold; and
output the filtered candidate exclusion objects as a set of exclusion objects for use by a coverage-gap analysis system.

17. The apparatus of claim 16, wherein
the instructions further cause the apparatus to divide the insurance policy text into a plurality of sections of bounded length prior to constructing the prompt, and
to include in the prompt only one of the plurality of sections at a time such that the one of the plurality of sections is of a length suitable for a context window of the LLM processing engine.

18. The apparatus of claim 16, wherein
the LLM processing engine is accessed by the one or more processors via an application programming interface over a network coupled to a network hardware of the apparatus.

19. The apparatus of claim 16, wherein
parsing the textual response comprises validating the textual response against a predetermined schema and, upon detecting that the textual response does not satisfy the predetermined schema, re-prompting the LLM processing engine with an indication of a malformed-output condition to obtain a replacement textual response.

20. The apparatus of claim 16, wherein
each candidate exclusion object having a confidence score below the predetermined threshold is flagged for human review through a user interface prior to being excluded from the set of exclusion objects.
